(19) United States
(12) Patent Application Publication
(10) Pub. No.: US 2016/0335604 A1
(43) Pub. Date: Nov. 17, 2016

(54) MULTI-PROGRAM SCHEDULING PLATFORM WITH SHARING

(71) Applicant: SJ MedConnect, Inc., Santa Clara, CA (US)

(72) Inventors: Jason Reminick, Santa Clara, CA (US); Suzanne Karan, Rochester, NY (US)

(21) Appl. No.: 14/711,215

(22) Filed: May 13, 2015

(51) Int. Cl. G06Q 10/10; H04L 29/08

(52) U.S. Cl. CPC G06Q 10/1095; H04L 67/306; H04L 67/18

(57) ABSTRACT

A system and method for scheduling with sharing, including: scheduling one or more of a plurality of event programs for a set of registered users via a scheduling platform; obtaining a set of sharing settings from a first registered user of the registered users that define a set of conditions for sharing a set of information pertaining to one or more of the event programs scheduled by the first registered user with the registered users other than the first registered user; and sharing the information with one or more of the registered users other than the first registered users in accordance with the sharing settings.

### BACKGROUND

Organizations, e.g., schools, businesses, government agencies, etc., can hold event programs that can be scheduled by interested individuals. For example, a professional school can hold an interview event program for interviewing applicants to the professional school. Similarly, a businesses or other type of institution can hold an interview event program for interviewing job applicants. Individuals may also seek to schedule professional conferences, e.g., medical conferences in particular medical specialties.

Interested individuals can schedule an event program by communicating directly with the organization holding the event program. For example, professional school applicants can schedule interview slots in an interview event program held by a professional school by communicating directly with the professional school. An interested individual can schedule with a number of a similar event programs. For example, medical students applying for residency positions can schedule interview slots in a number of interview event programs held by a number of different residency programs in their specialty of choice by communicating directly with each residency program in the affiliated institution.

### SUMMARY

In general, in one aspect, the invention relates to a scheduling platform with sharing. The scheduling platform can include: a scheduling module that enables a set of registered users of the scheduling platform to schedule one or more of a plurality of event programs; a sharing module that enables a first registered user of the registered users to share a set of information pertaining to one or more of the event programs scheduled by the first registered user via the scheduling module with one or more of the registered users other than the first registered users in accordance with a set of sharing settings; and a user profile module that enables the first registered user to use the sharing settings to define a set of conditions for sharing the information with the registered users other than the first registered user.

In general, in another aspect, the invention relates to a method for scheduling with sharing. The method can include: scheduling one or more of a plurality of event programs for a set of registered users via a scheduling platform; obtaining a set of sharing settings from a first registered user of the registered users that define a set of conditions for sharing a set of information pertaining to one or more of the event programs scheduled by the first registered user with the registered users other than the first registered user; and sharing the information with one or more of the registered users other than the first registered users in accordance with the sharing settings.

Other aspects of the invention will be apparent from the following description and the appended claims.

### BRIEF DESCRIPTION OF THE DRAWINGS

Embodiments of the present invention are illustrated by way of example, and not by way of limitation, in the figures of the accompanying drawings and in which like reference numerals refer to similar elements.

FIG. 1 illustrates a scheduling platform with sharing in one or more embodiments.

FIG. 2 illustrates a user interface in one or more embodiments that enables a set of registered users of a scheduling platform to create a corresponding set of user profiles.

FIG. 3 illustrates a user interface in one or more embodiments that enables a set of registered users of a scheduling platform to select a corresponding set of sharing settings.

FIG. 4 illustrates a scheduling calendar generated by a scheduling module in one or more embodiments of a scheduling platform.

FIG. 5 shows an itinerary module that enables a set of registered users of a scheduling platform to create and share itineraries for attending event programs.

FIG. 6 illustrates a user interface that enables a set of registered users of a scheduling platform to create and edit itineraries.

FIG. 7 illustrates a sharing module generating a list of sharing candidates.

FIG. 8A shows an example of a list of sharing candidates presented to a registered user in a user interface.

FIG. 8B shows a user interface that enables a registered user to accept or decline a sharing invite from another registered user.

FIG. 9 illustrates a messaging module in one or more embodiments of a scheduling platform.

FIG. 10 shows a program ratings module and a partner ratings module in one or more embodiments of a scheduling platform.

FIGS. 11A-11B shows user interfaces that enable a set of registered users of a scheduling platform to rate event programs and rate other users as travel partners.

FIG. 12 illustrates a user interface that enables a set of registered users of a scheduling platform to rate event programs in one or more embodiments

FIG. 13 illustrates a method for scheduling with sharing in one or more embodiments.

FIG. 14 illustrates a computing system upon which portions of a scheduling platform with sharing can be implemented.

### DETAILED DESCRIPTION

Reference will now be made in detail to the various embodiments of the present disclosure, examples of which are illustrated in the accompanying drawings. Like elements in the various figures are denoted by like reference numerals for consistency. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, have not been described in detail so as not to unnecessarily obscure aspects of the present disclosure.

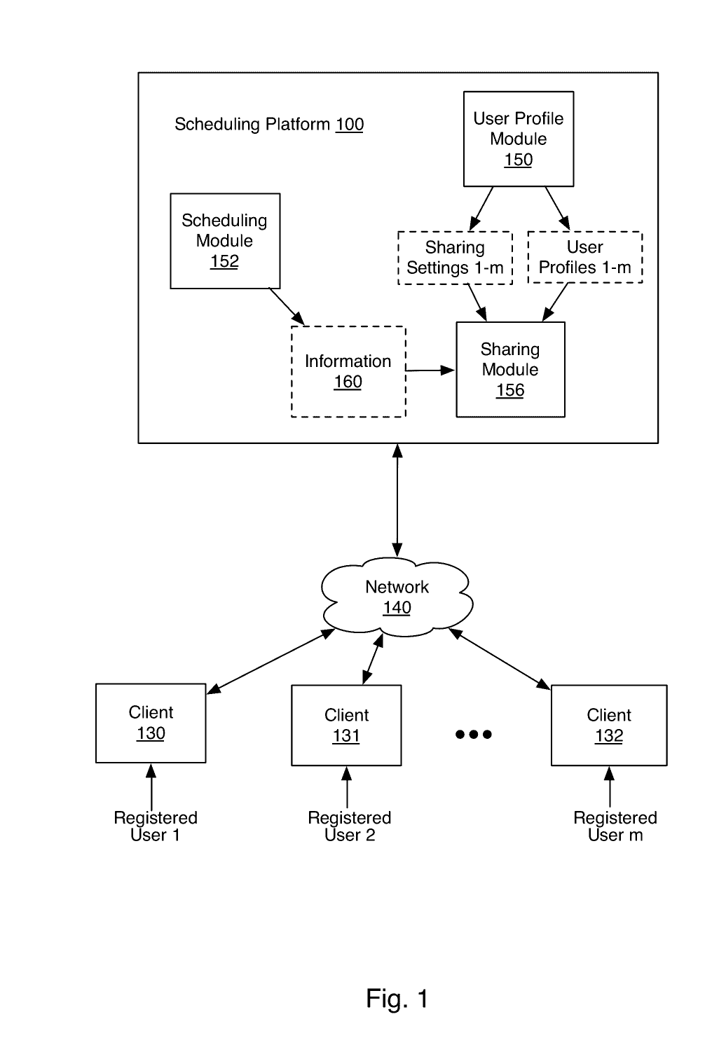

FIG. 1 illustrates a scheduling platform 100 with sharing in one or more embodiments. The scheduling platform 100 includes a scheduling module 152 that enables a set of registered users 1-m of the scheduling platform 100 to schedule one or more of a plurality of event programs 1-n that can be scheduled via the scheduling platform 100. There can be any number, n, of event programs 1-n and any number, m, of registered users 1-m. Each event program 1-n can include multiple sets of event slots. One or more of the registered users 1-m can seek to schedule event slots in more than one event program 1-n.

The event programs 1-n can be similar programs associated with different institutions. The event programs 1-n can be held at times of the year that coincide with traditional operations of institutions, e.g. the traditional school year for educational institutions or fiscal years for government or business institutions. In one embodiment, the event programs 1-n are interview days offered by different residency programs and the registered users 1-m are fourth-year medical students seeking residency positions.

The scheduling platform 100 includes a sharing module 156 that enables the registered users 1-m to share information pertaining to the event programs 1-n scheduled via the scheduling module 152 in accordance with a set of sharing settings 1-m. For example, the sharing module 156 enables the registered user 1 to share a set of information 160 pertaining to one or more of the event programs 1-n scheduled by the registered user 1 via the scheduling platform 100 with one or more of the registered users 2-m in accordance with the sharing settings 1.

The scheduling platform 100 includes a user profile module 150 that enables the registered users 1-m to use the sharing settings 1-m to define a set of conditions for sharing their information via the sharing module 156. For example, the user profile module 150 enables the registered user 1 to use the sharing settings 1 to define a set of conditions for sharing the information 160 with the registered users 2-m. The sharing module 156 can access a set of user profiles 1-m of the registered users 1-m when enforcing the conditions selected by the registered user 1.

The information 160 can be an itinerary for attending one or more of the event programs 1-n scheduled by the registered user 1 via the scheduling module 152. The information 160 can be ratings by the registered user 1 of one or more of the event programs 1-n attended by the registered user 1. The information 160 can be ratings by the registered user 1 of one or more of the registered users 2-m as a travel partner.

The conditions selectable via the sharing settings 1-m can be based on a friendship status of one or more of the registered users 1-m. The conditions selectable via the sharing settings 1-m can be based on an institution associated with one or more of the registered users 1-m. The conditions selectable via the sharing settings 1-m can be based on a geographic location of one or more of the registered users 1-m. The conditions selectable via the sharing settings 1-m can be based on a demographic characteristic, e.g., age, gender, etc., of one or more of the registered users 1-m.

The registered users 1-m can each use a respective client 130-132 to access the scheduling platform 100 via a network 140. The clients 130-132 can access the scheduling platform 100 using, e.g., web protocols by running a web browser. The clients 130-132 can be mobile devices running mobile apps adapted for accessing the scheduling platform 100, or any combination of mobile apps and web browser apps.

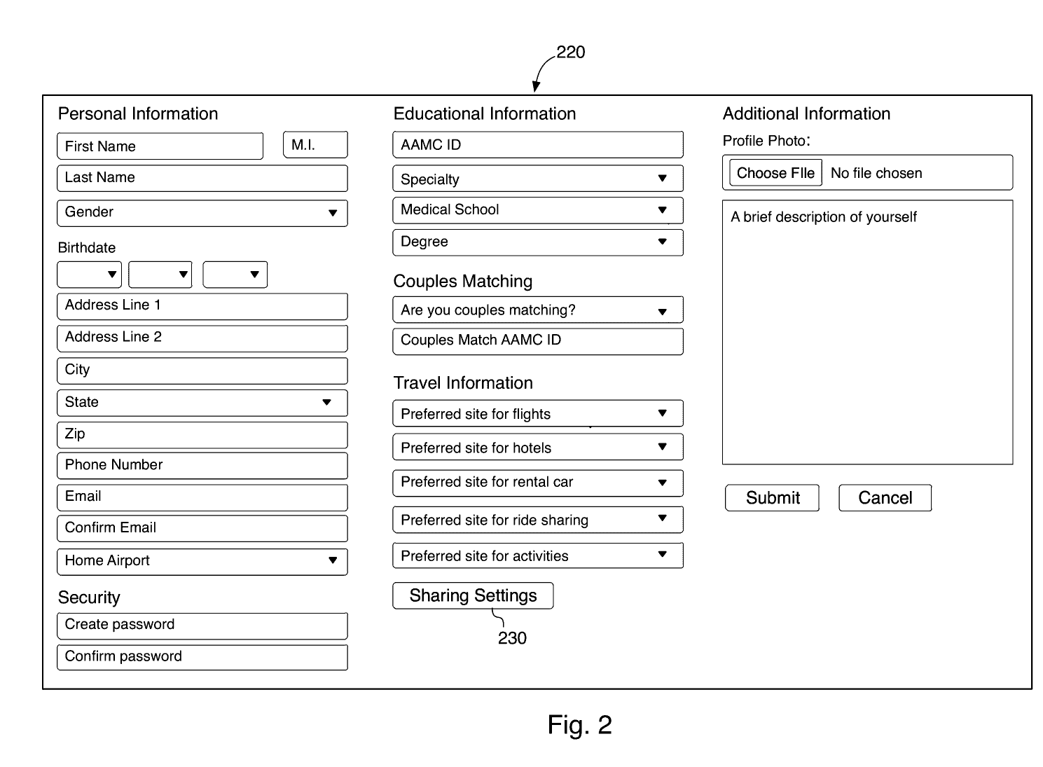

FIG. 2 illustrates a user interface 220 in one or more embodiments that enables the registered users 1-m to create the user profiles 1-m. The user interface 220 can be generated by the user profile module 150 and displayed on the clients 130-132.

The user profiles 1-m created via the user interface 220 can include a set of personal information including a birthdate, physical address and email address, and gender. The user profiles 1-m can include a set of educational information including an institution, e.g., a medical school, associated with a registered user. The user profiles 1-m can include a set of travel information that enables the registered users 1-m to specify a set of preferred booking sites. The preferred booking sites can include, for example, a preferred site for flights, a preferred site for hotels, and a preferred site for rental car, a preferred site for ride sharing, and a preferred site for activities.

The user profiles 1-m created via the user interface 220 can include a profile photo. The user interface 220 can include a “Choose File” button that enables each registered user 1-m to upload a photo from their corresponding client 130-132. The user interface 220 can enable the registered users 1-m to provide a brief description. The user interface 220 includes a button 230 that enables the registered users 1-m to select a set of sharing settings.

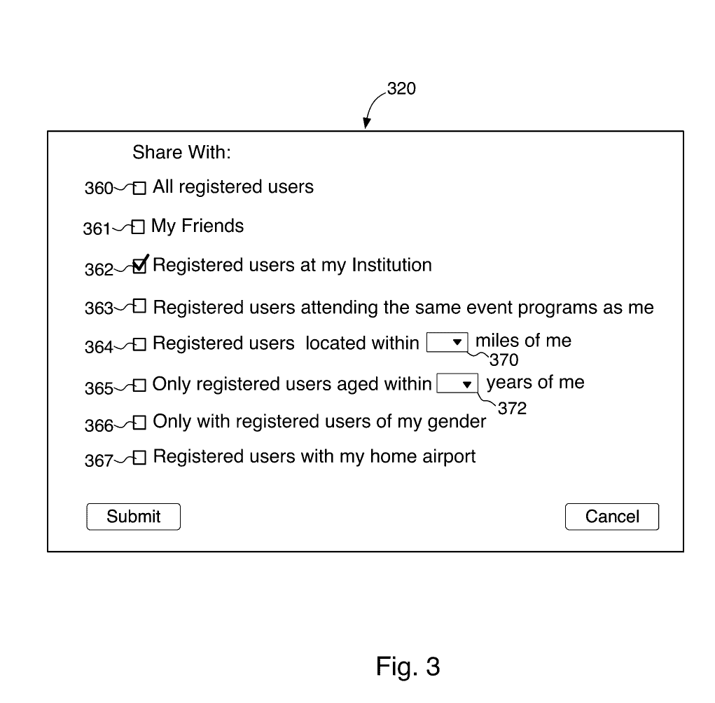

FIG. 3 illustrates a user interface 320 in one or more embodiments that enables the registered users 1-m to select the sharing settings 1-m. The user interface 320 can be generated by the user profile module 150 and displayed on the clients 130-132 when the button 230 in the user interface 220 is selected.

The user interface 320 in this example embodiment includes a set of conditions 360-366 with corresponding checkboxes that enable the registered users 1-m to select a set of conditions under which their information can be shared. The conditions 360-366 can be mutually exclusive or can be combined in any manner. The conditions 360-366 are by way of example and numerous other conditions and combinations of conditions are possible.

The condition 360 enables the registered users 1-m to specify that their information can be shared with all the other registered users 1-m of the scheduling platform 100. For example, if the registered user 1 checks the condition 360, the sharing module 156 will select all of the other registered users 2-m as candidates for sharing the information 160.

The condition 361 enables the registered users 1-m to specify that their information can be shared with the all of the other registered users 1-m who are designated as their Friend. For example, if the registered user 1 checks the condition 361, the sharing module 156 will select each registered user 2-m who is designated as a Friend by the registered user 1 as a candidate for sharing the information 160.

The condition 362 enables the registered users 1-m to specify that their information can be shared with each of the registered users 2-m who is associated with the same institution. For example, if the registered user 1 checks the condition 362, the sharing module 156 will select each registered user 2-m whose user profile 2-m specifies the medical school also specified by the registered user 1 in the educational information in the user profile 1 as a candidate for sharing the information 160.

The condition 363 enables the registered users 1-m to specify that their information can be shared with the other registered users 1-m who are attending the same event programs. For example, if the registered user 1 checks the condition 363, the sharing module 156 will examine the itineraries of the registered users 2-m and select those who are scheduled for the same event programs as the registered user 1 as candidates for sharing the information 160.

The condition 364 enables the registered users 1-m to specify that their information can be shared with the other registered users 1-m who are located within a range of miles specified in an input field 370. For example, if the registered user 1 checks the condition 364, the sharing module 156 will select the registered users 2-m who are located within the specified range of miles of the registered user 1 as candidates for sharing the information 160. The sharing module 156 can determine the locations of the registered users 1-m based on the information in the address fields of the user profiles 1-m or can use the current locations of one or more of the registered users 1-m as indicated by a locating mechanism, e.g., GPS, in mobile devices belonging to the registered users 1-m.

The condition 365 enables the registered users 1-m to specify that their information can be shared only with the other registered users 1-m who are within an age range of years specified in an input field 372 with respect to their own age. For example, if the registered user 1 checks the condition 365, the sharing module 156 will select only the registered users 2-m who are within the specified age range as candidates for sharing the information 160. The sharing module 156 can determine the ages of the registered users 1-m from birthdates entered via the user profiles 1-m.

The condition 366 enables the registered users 1-m to specify that their information can be shared only with the other registered users 1-m who are of the same gender. For example, if the registered user 1 checks the condition 366, the sharing module 156 will select only the registered users 2-m who are the same gender as the registered user 1 as candidates for sharing the information 160. The sharing module 156 can obtain the genders of the registered users 1-m from the user profiles 1-m.

The condition 367 enables the registered users 1-m to specify that their information can be shared with each of the registered users 2-m who is associated with the same home airport as the one entered in their user profile. For example, if the registered user 1 checks the condition 367, the sharing module 156 will select each registered user 2-m who specify the same home airport in their user profile 2-m as the home airport specified by the registered user 1 in the user profile 1 as a candidate for sharing the information 160.

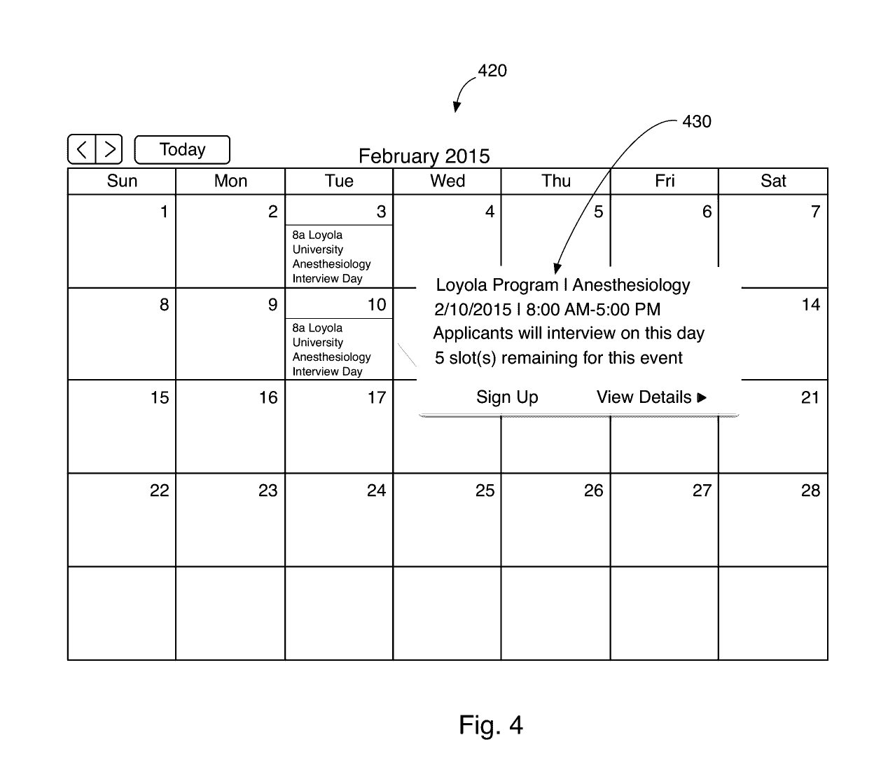

FIG. 4 illustrates a scheduling calendar 420 generated by the scheduling module 152 in one or more embodiments. The scheduling calendar 420 in this example enables the registered user 1 to schedule event slots in a Loyola University event program on the 3rd and 10th of February 2015. The scheduling module 152 generates a popup window 430 in response to the registered user 1 selecting the day view of 2/10/2015 for the Loyola event program. The popup window 430 informs the registered user 1 that 5 event slots remain for that day in the Loyola event program and includes a “Sign Up” link that enables the registered user 1 to confirm for that day and a “View Details” link that enables the registered user 1 to view details for the Loyola event program for that day.

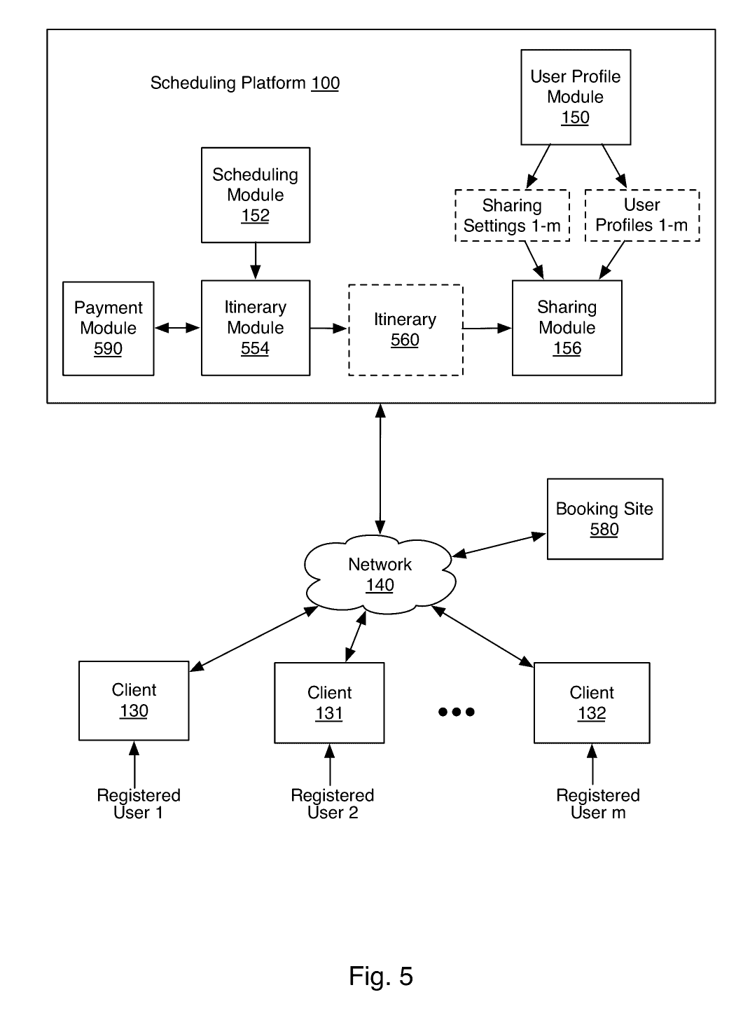

FIG. 5 shows an itinerary module 554 in the scheduling platform 100 that enables the registered users 1-m to create itineraries for attending the event programs 1-n scheduled via the scheduling module 152 and share the itineraries via the sharing module 156. For example, the itinerary module 554 enables the registered user 1 to create an itinerary 560 for attending the Loyola event program and share the itinerary 560 via the sharing module 156. The itinerary 560 in other examples can be for attending more than one or even all of the event programs 1-m confirmed by the registered user 1 via the scheduling module 152.

The itinerary module 554 can enable the registered users 1-n to access one or more booking sites, e.g., a booking site 580, via the network 140 when creating an itinerary. The booking sites can be web sites. The booking sites can include travel sites that enable selection and booking of flights, hotels, ground transport, etc., for a number of airlines, hotel brands, rental car companies, etc. The booking sites can be booking sites of individual airlines, hotel chains, rental car companies, etc. The booking sites can include booking sites of social events, entertainment events, etc. The booking sites can include sites for ride sharing companies, e.g., Uber, Lyft, Sidecar, and car sharing companies, e.g., Zip Car. The booking sites can include activity companies, e.g., AdventureBucketList, that enable the registered users 1-m to book activities such as skydiving, kayaking, and other types of activities on their travel. The scheduling platform 100 includes a payment module 590 that enables the registered users 1-m to pay, e.g. credit card, PayPal, etc., for the bookings made via the itinerary module 554.

The booking site 580 can be a preferred booking site specified via the user profiles 1-m or can be a default booking site, e.g. Orbitz, Priceline, etc., for the scheduling platform 100. A default booking site can be accessed using an API provided to the scheduling platform 100 by the default booking site. For example, the scheduling platform 100 can access Orbitz via an API provided by Orbitz that enables the registered users 1-m to access Orbitz booking functions through the scheduling platform 100.

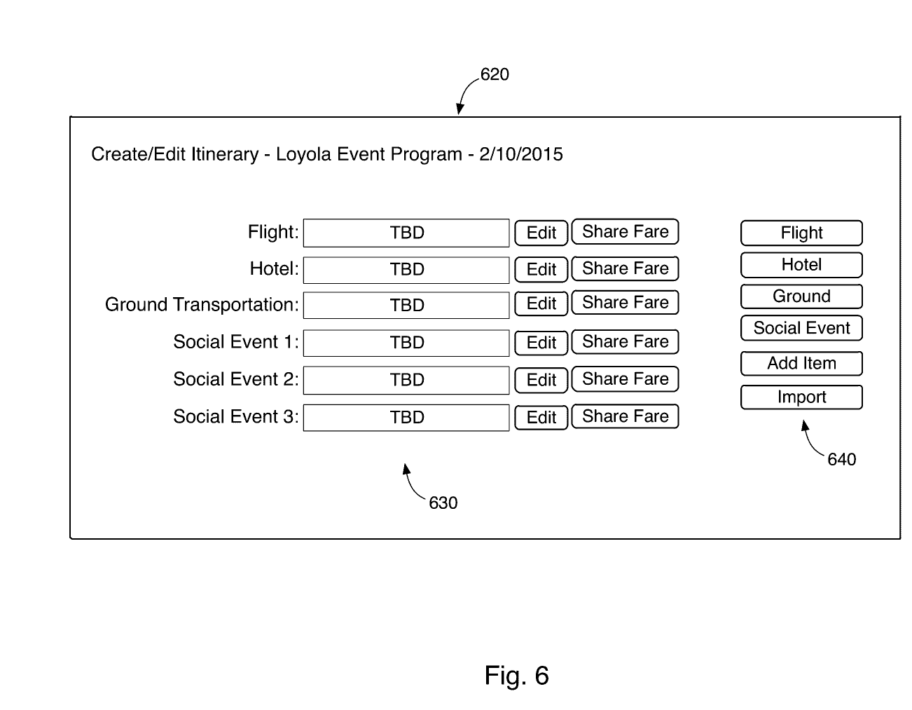

FIG. 6 illustrates a user interface 620 that enables the registered users 1-m to create and edit itineraries for the event programs scheduled via the scheduling module 152. The user interface 620 can be displayed to the registered users 1-m on the clients 130-132. For example, the itinerary module 554 can present the user interface 620 to the registered user 1 on the client 130 to create the itinerary 560 in response to the registered user 1 confirming an event slot of 2/10/2015 for the Loyola event program.

The user interface 620 can also enable the registered users 1-m to access shared itineraries. For example, the itinerary module 554 can present the user interface 620 to the registered user 2 on the client 131 to provide the registered user 2 with access to the itinerary 560 when the registered user 2 accepts a sharing invite from the registered user 1 to share the itinerary 560.

The user interface 620 includes a set of itinerary items 630. In this example, the itinerary items include flight, hotel, ground transportation, and a set of social events 1-3. The itinerary items 630 can all be initialized as TBD, i.e., to be determined, by the itinerary module 554.

The user interface 620 includes a set of buttons 640 for filling in the itinerary items 630. The buttons 640 can be individually selected by the registered users 1-m, e.g., by touching or clicking In one or more embodiments, the itinerary module 554 accesses one or more booking sites, e.g., a default booking site or a preferred booking site, when the registered users 1-m select the buttons 640 for flight, hotel, ground, and social event.

In one or more embodiments, the itinerary module 554 can access a default booking site for the scheduling platform 100 when the buttons 640 are selected and no corresponding preferred booking site is specified. For example, the itinerary module 554 can access a default booking site for the scheduling platform 100 when the “Flight” button is selected by the registered user 1 and no preferred booking site for flights is specified in the user profile 1. Otherwise, the itinerary module 554 can access the preferred booking site for flights specified in the user profile 1. Similarly, the itinerary module 554 can access a default booking site for the scheduling platform 100 when the “Flight” button is selected by the registered user 2 and no preferred booking site for flights is specified in the user profile 2 and access the preferred booking site for flights specified in the user profile 2 otherwise.

In one or more embodiments, each itinerary item 630 has a corresponding “Edit” button. The Edit buttons enable the registered users 1-m to edit the corresponding itinerary items. For example, the Edit button for the flight itinerary item can enable the registered user 1 to edit the flight information in the itinerary 560, e.g., by accessing a default booking site or the preferred booking site for flights specified in the user profile 1. Likewise, the Edit button for the flight itinerary item can enable the registered user 2 (who has accepted a sharing invite for the itinerary 560) to edit the flight information in the itinerary 560, e.g., by accessing a default booking site or the preferred booking site for flights specified in the user profile 2.

In one or more embodiments, each itinerary item 630 has a corresponding “Share Fare” button. The Share Fare buttons enable the registered users 1-m to share the cost of the corresponding itinerary items. For example, the Share Fare button for the ground transportation itinerary item can enable the registered user 2 to share the ground transportation cost for the itinerary 560. Likewise, the Share Fare button for the ground transportation itinerary item can enable the registered user 3, after accepting a sharing invite, to subsequently create a three way sharing of the cost of ground transportation in the itinerary 560.

Fares can be shared in numerous ways. For example, fare funds can be reimbursed to the registered user 1 via, e.g., the payment module 590, when the registered user 2 shares a fare already paid by the registered user 1. The itinerary module 554 can generate an accounts ledger for the itinerary 560 that records payments due for each registered user 1-m involved in sharing each itinerary item of the itinerary 560. For example, if three registered users share the cost of an itinerary item that has yet to be paid, the accounts ledger can divide the fare evenly among the three registered users.

The buttons 640 include an “Add Item” button that the registered users 1-m can use to add itinerary items. For example, the registered users 1-m can use the Add Item button to add flight, hotel, ground transportation, or social events to the itinerary 560.

The buttons 640 include an “Import” button that enables the registered users 1-m to import one or more itinerary items into the itinerary 560. For example, the registered users 1-m can import flights, hotels, etc., that were previously booked, into the itinerary 560. In one or more embodiments, the buttons 640 can include buttons that enable the registered users 1-m to print or cancel itineraries.

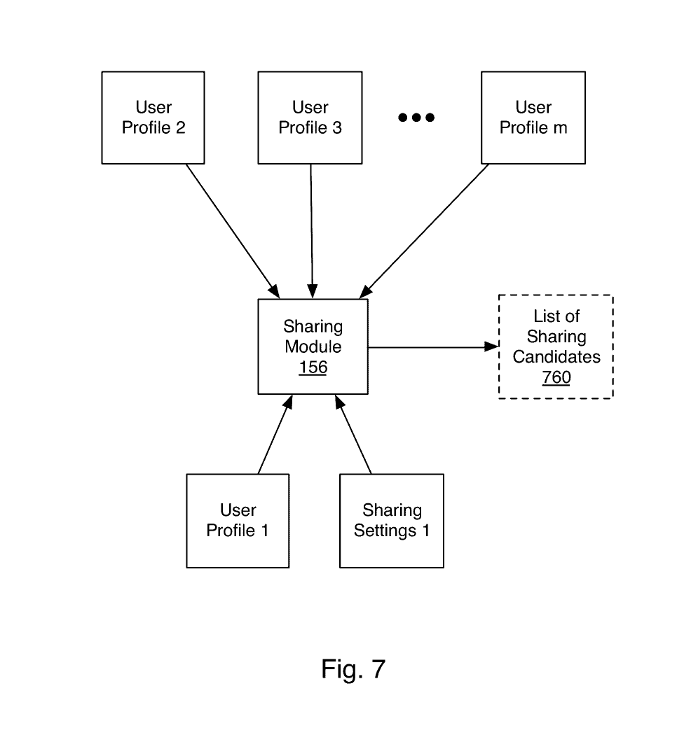

FIG. 7 illustrates the sharing module 156 generating a list of sharing candidates 760 for sharing the itinerary 560. The list 760 includes the registered users 2-m with whom the itinerary 560 of the registered user 1 can potentially be shared based on the sharing settings 1 and the user profiles 1-m.

In this example, the sharing settings 1 indicate that the registered user 1 has checked the condition 362 to enable sharing with the registered users 2-m associated with the same institution as the registered user 1 and has left the conditions 360-361 and 363-367 (FIG. 3) unchecked. The sharing module 156 selects the registered users 2-m having an institution specified in their respective user profile 2-m that match the institution specified in the user profile 1 for inclusion in the list of sharing candidates 760. In this example embodiment, the institution matched by the sharing module 156 is a medical school specified in the educational information of the user profile 1.

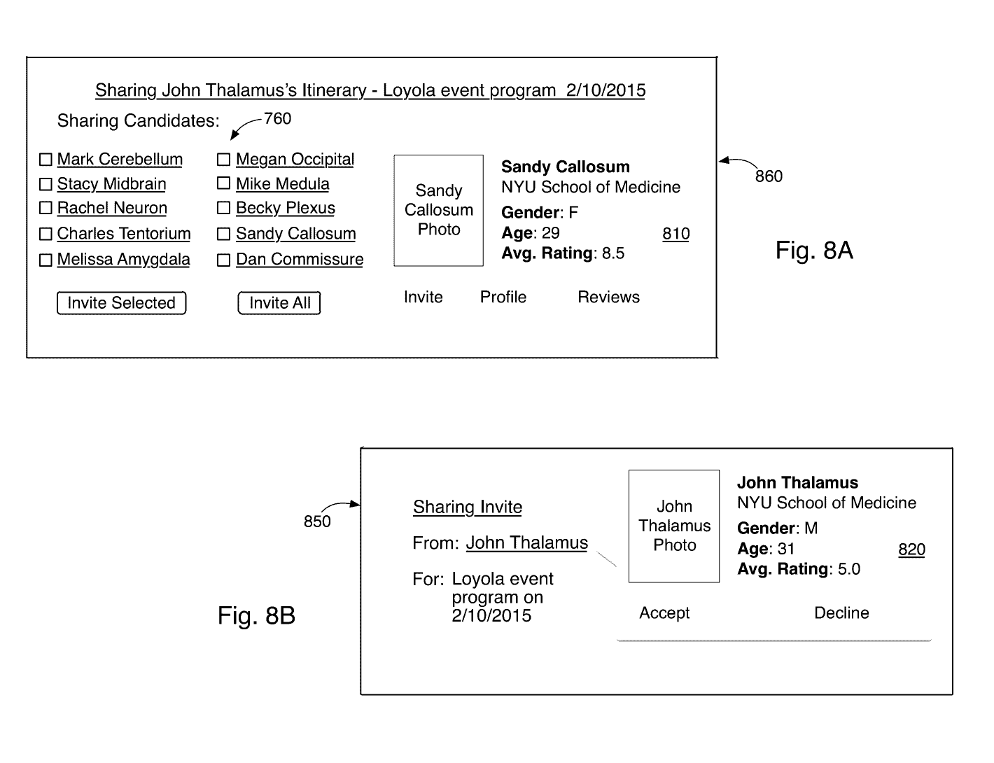

FIG. 8A shows an example of the list of sharing candidates 760 presented to the registered user 1 in a user interface 860. The user interface 860 can be generated by the sharing module 156 and displayed to the registered user 1 on the client 130 via, e.g., a web page or popup window, etc.

The registered user 1, in this example John Thalamus, can select any of the sharing candidates 760 to obtain more information and to send them a sharing invite. For example, in response to the registered user 1 selecting Sandy Callosum, the sharing module 156 displays a popup card 810 that corresponds to Sandy Callosum. The popup card 810 includes a photo of Sandy Callosum from her user profile and a set of basic information from her user profile. The popup card 810 includes an “Invite” link that when selected by the registered user 1 causes the sharing module 156 to send a sharing invite to Sandy to share the itinerary 560. The popup card 810 includes a “Profile” link that enables the registered user 1 to obtain more information about Sandy including information from her user profile.

The user interface 860 in one or more embodiments includes a checkbox for each of the sharing candidates 760. The checkboxes enable John Thalamus, in this example, to select multiple sharing candidates by checking one or more of the checkboxes for the sharing candidates 760. John can then send each one of the checked sharing candidates a sharing invite as a batch via an “Invite Selected” button. The user interface 860 in one or more embodiments includes an “Invite All” button that enables John, in this example, to send a sharing invite to all of the sharing candidates 760.

FIG. 8B shows a user interface 850 that enables Sandy Callosum to accept or decline the sharing invite from John Thalamus. The user interface 850 can be presented on the client 130-132 used by Sandy to access the scheduling platform 100. The user interface 850 identifies John Thalamus as the originator of the sharing invite and identifies the event program for the sharing invite. When Sandy selects John Thalamus in the user interface 850, a popup card 820 is generated that includes a photo of John Thalamus from his user profile and a set of basic information from his user profile. The popup card 820 includes an “Accept” link that enables Sandy to accept the sharing invite a “Decline” link that enables her to decline.

The sharing module 156 can send a sharing invite to Sandy Callosum using any form of communication, e.g., email, instant message, automated voice, message posts, http/html, text messages, push notifications, etc. For example, the sharing module 156 can send an email or instant message to a client device of Sandy Callosum that includes a link to a page on the scheduling platform 100 that enables Sandy to accept or decline the sharing invite, e.g., a page according to the user interface 850.

If Sandy Callosum accepts the sharing invite then the sharing module 156 enables Sandy to view the itinerary 560. For example, the sharing module 156 can send an email or instant message to Sandy with a link to a page on the scheduling platform 100 that enables Sandy to view and edit the itinerary 560 and share fares, e.g., a page according to the user interface 620 (FIG. 6). Conversely, Sandy may then share her itinerary with John Thalamus, e.g., by sending a sharing invite back to John via the sharing module 156, so that he may opt to share some of Sandy's itinerary options as well. For example, Sandy may wish to share the cost John's hotel room, while John may then choose to share the cost of Sandy's rental car.

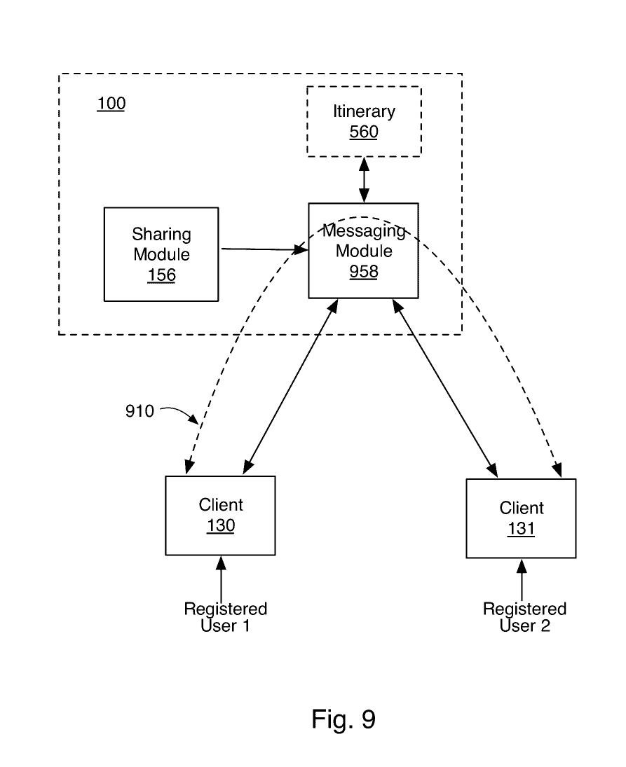

FIG. 9 illustrates a messaging module 958 in one or more embodiments of the scheduling platform 100 that provides a communication channel 910 that enables the registered user 1, John Thalamus, and the registered user 2, Sandy Callosum, to communicate regarding the sharing of the itinerary 560. The communication channel 910 can be based on email communication, instant messaging, message boards, etc., to name a few examples.

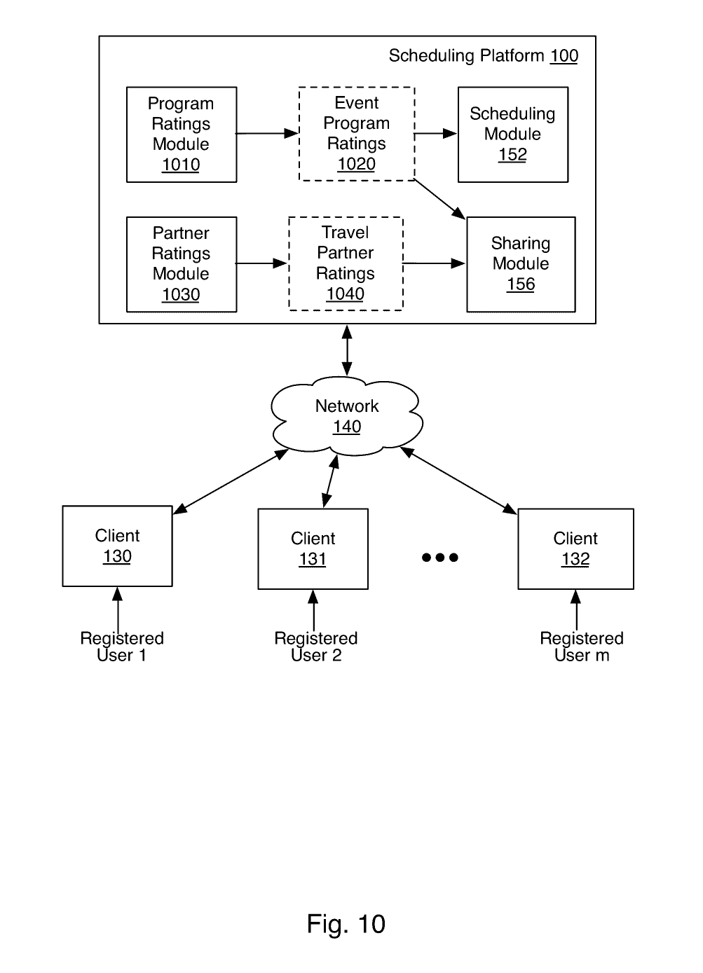

FIG. 10 shows a program ratings module 1010 in one or more embodiments of the scheduling platform 100. The program ratings module 1010 enables the registered users 1-m to rate the event programs 1-n based on their experiences with the event programs 1-n and share their ratings with other registered users via the sharing module 156. For example, the program ratings module 1010 enables the registered user 1 to generate a set of event program ratings 1020 based on their experiences with one or more of the event programs 1-n, e.g., the Loyola University event program attended by the registered user 1, and share the event program ratings 1020 with the registered users 2-m in accordance with the sharing settings 1.

The scheduling module 152 can display the event program ratings 1020 to the registered users 1-m when scheduling the event programs 1-m for the registered users 1-m. For example, when a registered user selects the “View Details” link in the popup window 430 of the scheduling calendar 420 (FIG. 4) the scheduling module 152 can display an aggregate of event program ratings from the registered users 1-m for the Loyola event program being scheduled.

Also shown in FIG. 10 is a partner ratings module 1030 that enables the registered users 1-m to rate the other registered users 1-m as travel partners based on their experiences with the other registered users 1-m and share their experiences via the sharing module 156. For example, the partner ratings module 1030 enables the registered user 1 to generate a set of travel partner ratings 1040 based on the experiences of the registered user 1 with one or more of the registered users 2-m and to share the travel partner ratings 1040 with the registered users 2-m in accordance with the sharing settings 1.

The sharing module 156 can display the relevant travel partner ratings when the registered users 1-m are selecting candidates for sharing. For example, the sharing module 156 can display the relevant travel partner ratings in the popup card 810 (FIG. 8A) when the registered user 1 is evaluating potential travel partners. The “Reviews” link in the popup card 810 can bring up another view that provides more detailed evaluations of Sandy Callosum as a travel partner made by one or more of the other registered users 1-m. In one or more embodiments, the sharing module 156 can exclude the registered users 1-m who rank below a certain threshold as travel partners from a list of sharing candidates for the registered users 1-m who specified the low ranking For example, if Sandy gives John a low enough ranking then he will no longer appear in lists of sharing candidates presented to Sandy.

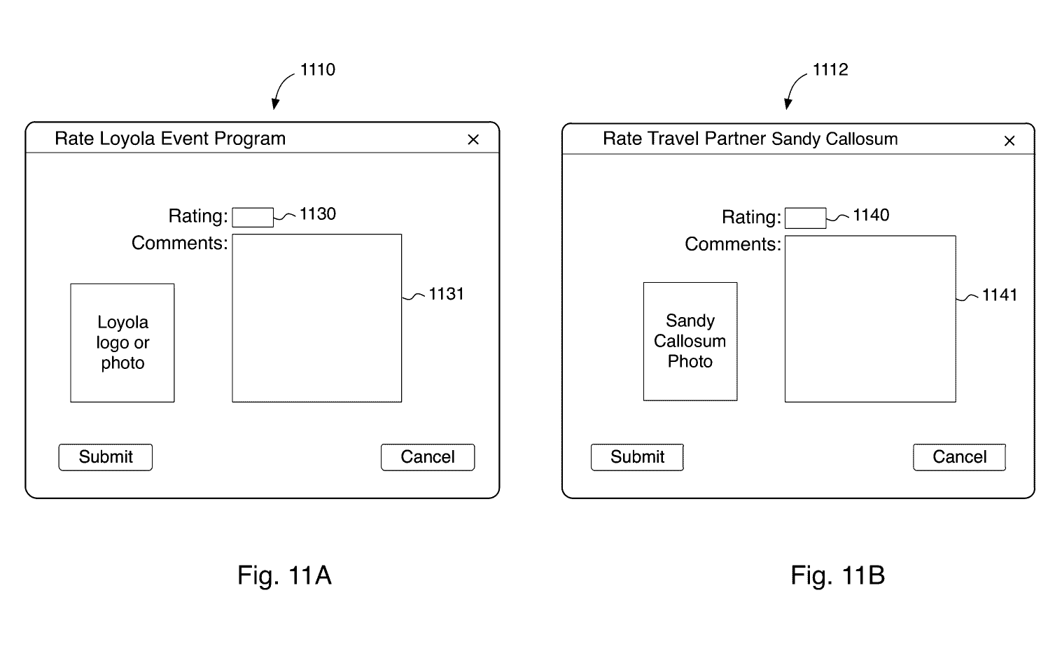

FIG. 11A shows a user interface 1110 that enables the registered users 1-m to rate event programs after attending. In this example, the user interface 1110 enables the registered user 1 to rate the Loyola event program. The user interface 1110 can be generated by the program ratings module 1010 for display on the client 130 of the registered user 1. The user interface 1110 includes an input field 1130 that enables the registered user 1 to specify an overall rating of the experience, e.g., number of stars, a scale of 1-10, grade scale, etc. The user interface 1110 includes an input field 1131 that enables the registered user 1 to provide a description of their experiences attending the Loyola event program.

FIG. 11B shows a user interface 1112 that enables the registered users 1-m to rate other registered users 1-m as travel partners. In this example, the user interface 1112 enables the registered user 1 to rate Sandy Callosum as a travel partner. The user interface 1112 can be generated by the partner ratings module 1030 for display on the client 130 of the registered user 1. The user interface 1112 includes an input field 1140 that enables the registered user 1 to specify an overall rating, e.g., number of stars, a scale of 1-10, grade scale, etc. The user interface 1112 includes an input field 1141 that enables the registered user 1 to provide a description of their experiences with Sandy.

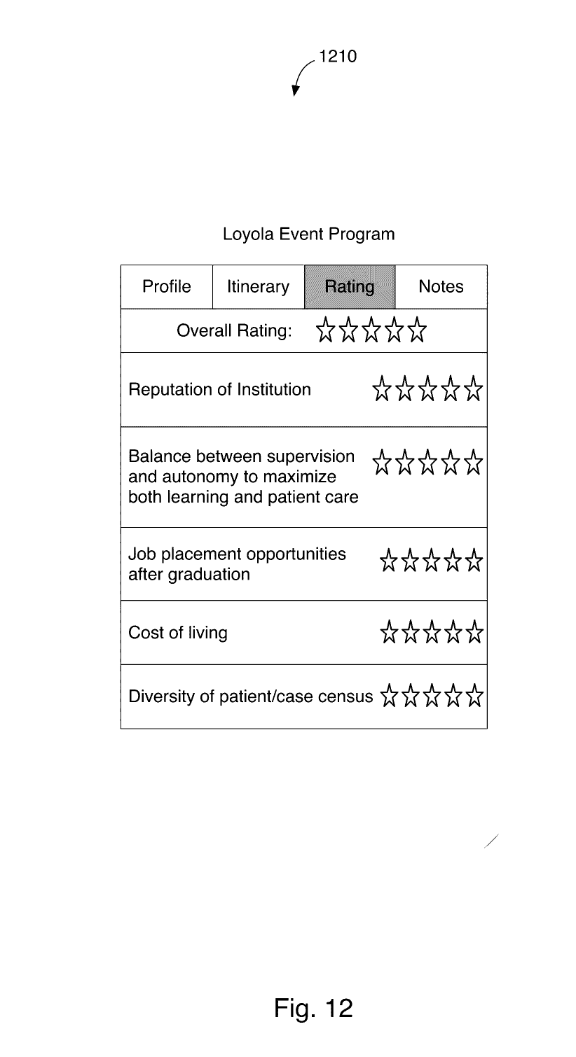

FIG. 12 illustrates a user interface 1210 that enables the registered users 1-m to rate event programs in one or more embodiments. In this example, the user interface 1210 enables the registered user 1 to rate the Loyola event program using their mobile device. The user interface 1210 can be generated by the program ratings module 1010 for display on a mobile client of the scheduling platform 100. The user interface 1210 provides the registered user 1 with the ability to provide an overall rating for the Loyola event program based on a number of stars. The user interface 1210 also provides the registered user 1 with the ability to provide a ratings breakdown for the Loyola event program based on a number of stars in each of a set of ratings aspects, e.g. academic medical center program, appropriate balance, etc. The registered user 1 can select the star ratings via touchscreen input on their mobile device. Such ratings can be made viewable to other registered user via an event program profile of the particular event program.

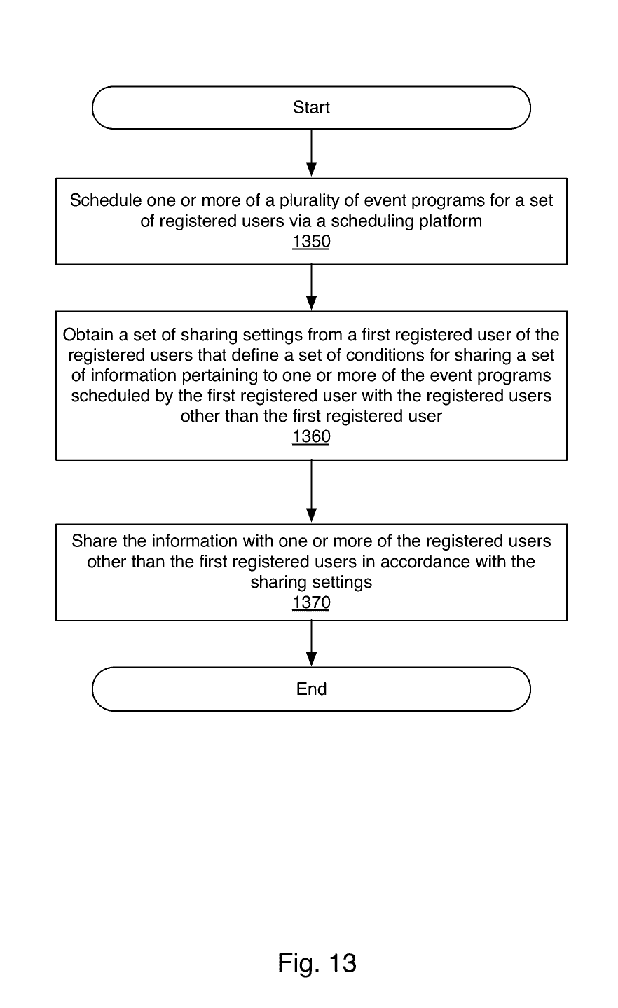

FIG. 13 illustrates a method for scheduling with sharing in one or more embodiments. While the various steps in this flowchart are presented and described sequentially, one of ordinary skill will appreciate that some or all of the steps can be executed in different orders and some or all of the steps can be executed in parallel. Further, in one or more embodiments, one or more of the steps described below can be omitted, repeated, and/or performed in a different order. Accordingly, the specific arrangement of steps shown in FIG. 13 should not be construed as limiting the scope of the invention.

At step 1350, one or more of a plurality of event programs are scheduled by a set of registered users via a scheduling platform. At step 1360, a set of sharing settings is obtained from a first registered user of the registered users that define a set of conditions for sharing a set of information pertaining to one or more of the event programs scheduled by the first registered user with the registered users other than the first registered user. At step 1370, the information is shared with one or more of the registered users other than the first registered users in accordance with the sharing settings.

Embodiments of the invention may be implemented on a specialized computer system. Examples of such a computing system can include one or more mobile devices (e.g., laptop computer, smart phone, personal digital assistant, tablet computer, or other mobile device, game console), desktop computers, servers, blades in a server chassis, or any other type of computing device(s) that include at least the minimum processing power, memory, and input and output device(s) to perform one or more embodiments of the invention.

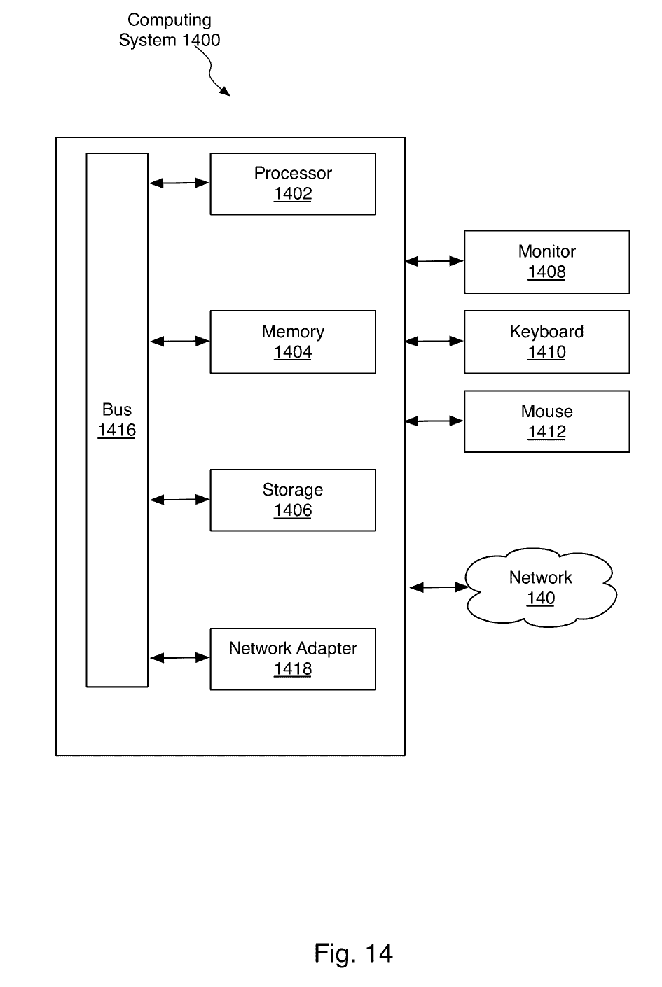

FIG. 14 illustrates a computing system 1400 upon which portions of the scheduling platform 100 can be implemented. For example, the modules and data structures of the scheduling platform 100 can be implemented in code running on the computing system 1400. The clients 130-132 can be implemented in code on similar mobile or desktop/laptop computing systems.

The computing system 1400 includes one or more computer processor(s) 1402, associated memory 1404 (e.g., random access memory (RAM), cache memory, flash memory, etc.), one or more storage device(s) 1406 (e.g., a hard disk, an optical drive such as a compact disk (CD) drive or digital versatile disk (DVD) drive, a flash memory stick, etc.), a bus 1416, and numerous other elements and functionalities. The computer processor(s) 1402 may be an integrated circuit for processing instructions. For example, the computer processor(s) may be one or more cores or micro-cores of a processor. The computing system 1400 may also include one or more input device(s), e.g., a touchscreen, keyboard 1410, mouse 1412, microphone, touchpad, electronic pen, or any other type of input device. Further, the computing system 1400 may include one or more monitor device(s) 1408, such as a screen (e.g., a liquid crystal display (LCD), a plasma display, touchscreen, cathode ray tube (CRT) monitor, projector, or other display device), external storage, input for an electric instrument, or any other output device. The computing system 1400 may be connected to the network 140 (e.g., a local area network (LAN), a wide area network (WAN) such as the Internet, mobile network, or any other type of network) via a network adapter 1418.

While the foregoing disclosure sets forth various embodiments using specific diagrams, flowcharts, and examples, each diagram component, flowchart step, operation, and/or component described and/or illustrated herein may be implemented, individually and/or collectively, using a range of processes and components.

The process parameters and sequence of steps described and/or illustrated herein are given by way of example only. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While the invention has been described with respect to a limited number of embodiments, those skilled in the art, having benefit of this disclosure, will appreciate that other embodiments may be devised which do not depart from the scope of the invention as disclosed herein.

What is claimed is:

1. A scheduling platform with sharing, comprising:
a scheduling module that enables a set of registered users of the scheduling platform to schedule one or more of a plurality of event programs;
a sharing module that enables a first registered user of the registered users to share a set of information pertaining to one or more of the event programs scheduled by the first registered user via the scheduling module with one or more of the registered users other than the first registered users in accordance with a set of sharing settings; and
a user profile module that enables the first registered user to use the sharing settings to define a set of conditions for sharing the information with the registered users other than the first registered user.

2. The scheduling platform of claim 1, wherein the information comprises at least one itinerary for attending one or more of a set of event programs scheduled by the first registered user via the scheduling module.

3. The scheduling platform of claim 1, wherein the information comprises at least one rating of one or more of the event programs attended by the first registered user.

4. The scheduling platform of claim 1, wherein the information comprises at least one rating of one or more of the registered users other than the first registered user as a travel partner.

5. The scheduling platform of claim 1, wherein at least one of the conditions is based on a friendship status of one or more of the registered users.

6. The scheduling platform of claim 1, wherein at least one of the conditions is based on an institution associated with one or more of the registered users.

7. The scheduling platform of claim 1, wherein at least one of the conditions is based on a geographic location of one or more of the registered users.

8. The scheduling platform of claim 1, wherein at least one of the conditions is based on a demographic characteristic of one or more of the registered users.

9. The scheduling platform of claim 1, wherein the sharing module generates a list of sharing candidates from among the registered users other than the first registered user in response to the conditions, the list enabling the first registered user to send a sharing invite to one or more of the registered users on the list.

10. The scheduling platform of claim 1, further comprising an itinerary module that enables a subset of the registered users to share at least one cost associated with an itinerary for attending one or more of the event programs.

11. A method for scheduling with sharing, comprising:
scheduling one or more of a plurality of event programs for a set of registered users via a scheduling platform;
obtaining a set of sharing settings from a first registered user of the registered users that define a set of conditions for sharing a set of information pertaining to one or more of the event programs scheduled by the first registered user with the registered users other than the first registered user; and
sharing the information with one or more of the registered users other than the first registered users in accordance with the sharing settings.

12. The method of claim 11, wherein the information comprises at least one itinerary for attending one or more of a set of event programs scheduled by the first registered user.

13. The method of claim 11, wherein the information comprises at least one rating of one or more of the event programs attended by the first registered user.

14. The method of claim 11, wherein the information comprises at least one rating of one or more of the registered users other than the first registered user as a travel partner.

15. The method of claim 11, wherein at least one of the conditions is based on a friendship status of one or more of the registered users.

16. The method of claim 11, wherein at least one of the conditions is based on an institution associated with one or more of the registered users.

17. The method of claim 11, wherein at least one of the conditions is based on a geographic location of one or more of the registered users.

18. The method of claim 11, wherein at least one of the conditions is based on a demographic characteristic of one or more of the registered users.

19. The method of claim 11, further comprising generating a list of sharing candidates from among the registered users other than the first registered user in response to the conditions, and obtaining from the first registered user an indication to send a sharing invite to one or more of the registered users on the list.

20. The method of claim 11, further comprising sharing at least one cost associated with an itinerary for attending one or more of the event programs among a subset of the registered users.
